(19) United States
(12) Patent Application Publication
(10) Pub. No.: US 2001/0051982 A1
(43) Pub. Date: Dec. 13, 2001

(54) System and method for application specific chat room access

(76) Inventor: Paul Graziani, Wayne, PA (US)

Correspondence Address: Roberts Abokhair & Mardula, LLC, Suite 1000, 11800 Sunrise Valley Drive, Reston, VA, 20191-5302, US

(21) Appl. No.: 09/748,846

(22) Filed: Dec. 27, 2000

Related U.S. Application Data
(60) Provisional application No. 60/173,151, filed on Dec. 27, 1999.

(51) Int. Cl. G06F 15/16; G06F 9/54

(52) U.S. Cl. 709/204; 709/310

(57) ABSTRACT

The present invention, in one embodiment, comprises an application with a specific chat room access module associated with the application. When the user launches the application for the first time, the application is loaded in the normal fashion known in the art. When the chat room is reached, a window is opened on the user's application screen. Thus, when the user begins using the application program the chat room is automatically up and running so that the user can post questions to other users and to the application provider staff and have those questions answered in near real time.

### CROSS REFERENCE TO RELATED APPLICATIONS

This application claims priority under 35 U.S.C. § 119(e) from provisional application No. 60/173,151, filed Dec. 27, 1999. The 60/173,151 provisional application is incorporated by reference herein, in its entirety, for all purposes.

### BACKGROUND OF THE INVENTION

This invention relates generally to chat rooms on a network. More specifically the present invention is a system and method for accessing chat rooms in an automatic fashion upon the launch of an application.

Before the advent of the Internet certain software applications providers had established bulletin boards where questions could be posted and where staff for the application provider could post answers to questions. When a user began using a specific application or a particular problem arose, the user would go to the bulletin board for the specific application to hopefully find answers to questions. Otherwise questions could be posted and a staff member from the application provider would respond after some interval of time. This passage of time, however, is not satisfactory to most users who want immediate responses to their questions so they can get on with use of the application. Thus bulletin boards, while useful, have certain shortcomings.

With the advent of the Internet so-called “chat rooms” have come into being. As used within the context of this application a chat room is a place where multiple users and the application provider can all be online simultaneously and have electronic conversation posing questions and receiving answers in near real time. Chat rooms have grown up in such service providers as American Online (AOL) and through the utilities. These chat rooms allow users to interact with one another and potentially the chat room “monitor” in order to have the real time conversations. In addition, chat rooms have become more specific in that people can sign on to chat rooms which have a specific topic of the day such as middle eastern matters, and other pending current events. Thus the chat room function serves a useful purpose to allow this real time conversation to take place.

Also with the advent of the Internet many firms have posted web sites which serve the old bulletin board function. For example, on most application provider web sites there is a “frequently asked questions” (FAQ) section where a user can post a question concerning a specific application and that question will be answered in due course. Unfortunately, “due course” may be too slow for most users who want answers to questions regarding use of the application.

Development relating to chat room technology has been the subject of publication and invention. For example:

U.S. Pat. No. 5,933,599 (the '599 patent) to Nolan illustrates an interface program that mirrors a user's operating system when the user interfaces with another operating system and/or LAN over the Internet. Primarily, the '599 patent describes a tool to search files that create the same graphic display the user is used to seeing. This invention also features a shortcut function that is essentially a customized navigator. When the user places the icon in a given folder on his computer system, the software creates a shortcut. This shortcut allows the user to click on the icon, whether or not the user is on-line, and immediately launches into the location. However, the use of an on-line service provider is always needed.

At column 12, lines 34-48, a feature for creating a customized navigator for on-line help is contemplated. However, the specific elements necessary to perform this function are not disclosed.

The PCT application W09920026 (the '026 application) of Schindler illustrates an automatic chat room launching system. This system allows a user watching television to automatically connect to a chat room for people watching that specific program. The system can also automatically switch chat rooms as the user switches channels on the television. This system is specific to the use of a TV as the means by which the code is sent to the user to switch to a chat room.

U.S. Pat. No. 5,801,700 (the '700 patent) to Ferguson describes a software application that incorporates the click and drag method of file transfer over multiple domains, instead of in a single domain like a desk-top computer. The application allows file transfer to occur without opening any new windows. Using this feature in conjunction with using a chat room is additionally described (see column 7, lines 15-36). However, only the ability to transfer files between chat room users is described.

U.S. Pat. No. 5,694,163 (the '163 patent) to Harrison describes providing access to an Internet chat room through a television (TV) signal. As described, viewers can see the chat room exchange on their television without participating. Additionally, those who participate in the discussion have both the program and the chat window displayed on a computer screen. The chat data stream is incorporated into the TV signal. The TV signal is also encoded to be displayed on a computer.

The automatic access described occurs when a user does not have an on-line service provider, but wishes to participate in the chat. When this occurs, the user is automatically routed through the on-line service provider sponsoring the chat. This system is, however, limited to the use of a TV signal back channel for implementing a chat regarding the TV program in progress. It does not disclose or suggest a system for launching an application-specific chat session upon start up of a specific piece of software.

The PCT application W09903034 (the '034 application) of Shem-Tov illustrates software that operates chat rooms that are not dependent on a single server. With this software, a person can generate and participate in a chat room. Further described is the ability to change the chat room client list on a server simultaneously to the ongoing chat. This application does not describe providing help to a client that has not yet been able to connect.

U.S. Pat. No. 5,793,365 (the '365 patent) to Tang et al., illustrates an interface system for multiple users in a work group. Particularly, this system is designed to keep a work team in close contact regardless of whether they are in close physical proximity to each other. The interface system includes a chat room that allows users to share documents, as well as store documents that pertain to the subject of each discussion. The system accommodates various levels of hardware availability each user may have. The system automatically switches between text, video, and/or audio, according to what support each group member has, when conducting meetings.

The chat room interface allows a group member to view icons of a chat session to decide whether to enter the discussion. The icon displays information about the subject and current members of the discussion. A group member can click the icon to enter the discussion. These interactions occur within a network.

U.S. Pat. No. 5,919,247 (the '247 patent ) to Van Hoff et al., illustrates a system for automatically downloading software updates for registered customers of a software product. The '247 patent does not directly address problems associated with downloading chat room applications. The '247 patent does refer to using Java applets (see column 1, lines 37-44) to automatically run a program without the need for a downloaded software update. However, no abilities to access a chat room to obtain help when receiving the download is described.

U.S. Pat. No. 5,943,671 (the '671 patent) to Kleewein et al., illustrates an interface for heterogeneous database management systems. Here, an interface module automatically connects unrecognized database actions, allowing multiple actions to be pending on a single connection. Each connection is reassigned so that it does not seem to be pending so that new connections may be picked up and reassigned.

America Online has a function called AOL Instant Messenger (AIM). The AOL Instant Messenger is a facility that simply allows one AOL user to talk to another AOL user if the users are online simultaneously, and each of the users has designated the other as one who can receive instant messaging. Thus, it represents an automatic start for messaging, but only under certain conditions.

THE HOME NETWORKING BIBLE notes that most online chat programs start when a user connects to the Internet. The program then operates in the background, waiting for a chat “buddy” to get online. Again this is similar to the AOL AIM program. Further, the program begins only upon connection to the Internet. This is not the same as the mechanism contemplated by the present invention, which is first launched when the program is launched, thereby connecting the user to the internet and to the specific chat room directed to that program.

The reference HARLEY HAHN TEACHES THE INTERNET relates to Internet chat and the fact that an automated channel is kept open for Internet relay chat (IRC). This reference is cited for general chat room technology. It is not a product that is automatically launched upon the launching of an application program as in the present invention.

The reference SMART COMPUTING (volume 5, issue 12) notes the desirability of being able to collaborate in real time with other members of a network, and cites a number of chat room facilities. All of these, however, require separate launching and are not associated with an underlying application.

An article in INTERNET WORLD (October 1997) relates to “hosting your own chat”. The article notes that two separate programs offered by eShare Expressions or Earthweb's Moderator start automatically when one logs onto a website. However, once again this requires that a user access the Internet first in order for the chat program to launch.

An article in the September 1997 issue of COMPUTER NETWORKS AND ISDN SYSTEMS relates to certain mechanisms embedded into MIME email messages so that they are automatically started when the recipient reads the email message. This relates to the automatic starting of programs, but does not disclose the idea of automatic startup of an application-specific chat session upon the launching of a specific application.

What would be truly useful is system and method where by a user can access a chat room in an automated fashion upon launching a specific application and where the chat room relates specifically to the application in question.

### SUMMARY OF THE INVENTION

It is therefore an object of the present invention to apply chat room technology to the needs of users of a specific software application.

It is yet another object of the present invention to allow users to have access to an application specific chat room in which other users and application provider personnel are present to immediately respond to questions any particular user may have.

It is a further object of the present invention to allow an application specific chat room to be accessed by a user via the Internet.

It is yet another object of the present invention to have the application specific chat room launched automatically by the application when the application is launched.

It is yet another object of the present invention to have a chat session embedded within the software application to which it pertains.

It is a further object of the present invention to have an application-specific chat session launched automatically by the application when the application is launched and embedded within the application.

These and other objects of the present invention will become apparent to those skilled in the art from a review of the specification that follows.

The present invention, in one embodiment, comprises an application with a specific chat room access module associated with the application. When the user launches the application for the first time, the application is loaded in the normal fashion known in the art. However in addition, the chat room module checks to see if the individual workstation is connected to the Internet.

If the workstation is not connected to the Internet, a connection is made. Optionally, the chat room module may check to confirm if an Internet browser is present. If such a browser is present the chat room module launches the browser and connects the user to the Internet.

When the user is connected to the Internet, the chat room module supplies an IP address or universal resource locator (URL) to the program providing the Internet connection. In the event a browser is being used, this data is input into the address line of the browser. This address or URL is provided along with the application software when that software is provided to the user.

With the appropriate address entered, the user is automatically taken to the specific chat room associated with the IP address given in the application program. It should be noted that this address may be the specific address of the chat room or may be an address that allows a user to be redirected to where the chat room is located in the event that the chat room address changes from time to time.

When the chat room is reached, a window is opened on the user's application screen so that when the user begins using the application program the chat room is automatically up and running so that the user can post questions to other users and to the application provider staff and have those questions answered in near real time.

In this fashion an application specific chat room is automatically launched upon the launching of the application itself, thereby eliminating multiple steps in searching that might have to be undertaken by the user.

When the user is finished with the chat room, the chat room window can always be closed with the application still running. Thereafter, should the user desire to access the chat room, a button or icon can be actuated which will again launch the browser and take the user directly to the chat room associated to the application.

### BRIEF DESCRIPTION OF THE DRAWINGS

FIG. 1 illustrates a flowchart for launching the application and chat room.

FIG. 1A illustrates the continued flowchart for launching the application and chat room.

FIG. 2 illustrates a general network architecture for implementing embodiments of the present invention.

FIG. 3 illustrates a software architecture according to an embodiment of the present invention.

FIG. 4 illustrates operation according to an alternate embodiment of the present invention.

FIG. 5 illustrates operation according to further alternate embodiments of the present invention.

### DETAILED DESCRIPTION OF THE INVENTION

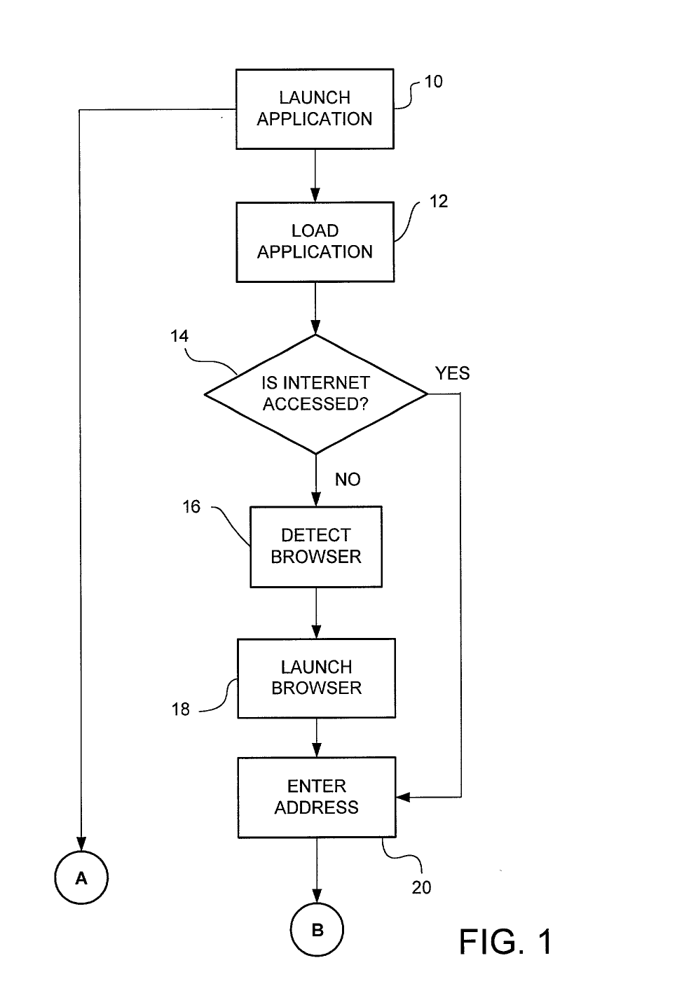

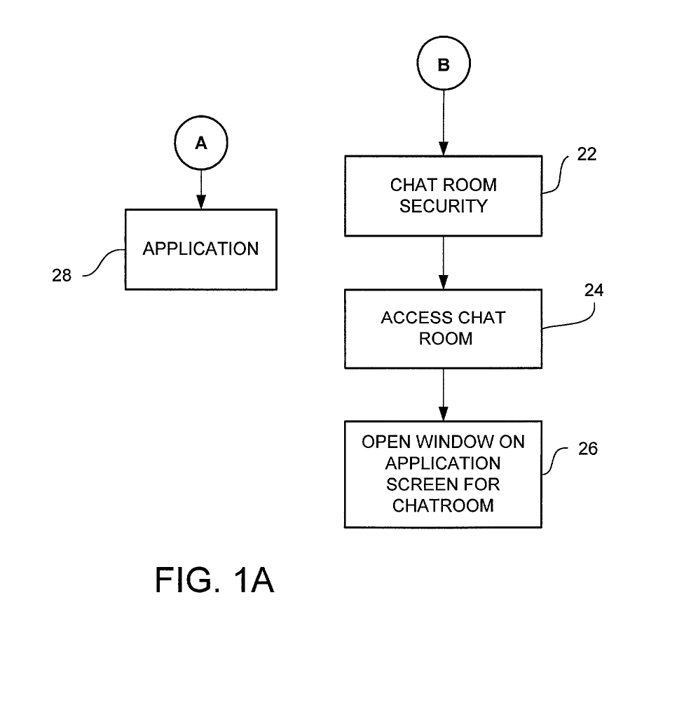

As noted above the present invention is an automated methodology for launching an application specific chat room. Referring to FIGS. 1 and 1A, a user launches the application 10 in the normal fashion. The application is then loaded on the user's computer 12. Thereafter the appropriate modules of the application are ready for use and displayed in a normal fashion on the user screen 28.

During this part of the loading process, the chat room module of the present invention determines whether the Internet has already been accessed for some other use 14. If the Internet has not been accessed, the chat room module optionally searches to detect the presence of a browser 16. When the browser is found the browser is launched 18 and an address that is provided along with the application is entered in the address line of the browser 20. Alternatively, if the Internet is accessed via another mechanism, the address is supplied to that mechanism.

If the Internet is being accessed already 14 the chat room module than proceeds directly to enter the Internet address provided along with the application software 20.

Upon reaching the Internet address of the chat room, optional chat room security procedures would be implemented 22. These security procedures are not required generally but may be desired by the application provider to monitor specifically who is accessing the chat room. The security procedures can be in the form of a “cookie” of the chat room to ensure the application provider that an authorized user is present. Alternatively a password can be stored and subsequently entered in an automated fashion upon signing on to the chat room. The password would be selected during the application setup procedure and thereafter provided automatically to the chat room. In this fashion there can be at least some assurance to the application provider that only authorized individuals access the chat room. Further this can serve as a check on any unauthorized users who may be accessing the chat room. In any case, once chat room security has been satisfied 22 the user is provided access to the chat room 24. Once access to the chat room is verified by the chat room module on the user's computer, a window is opened 26 in the application screen on the user's computer so that the application itself 28 is presented along with a small chat room window 26. The small chat room window 26 is configurable by the user to any size desired. In this fashion the user can access and use the application and when questions arise, post the questions to the chat room to be responded to by other users as well as by staff members of the application provider.

In the preferred embodiment, the chat room window 26 is embedded within the application. Alternatively, it could be a separate window.

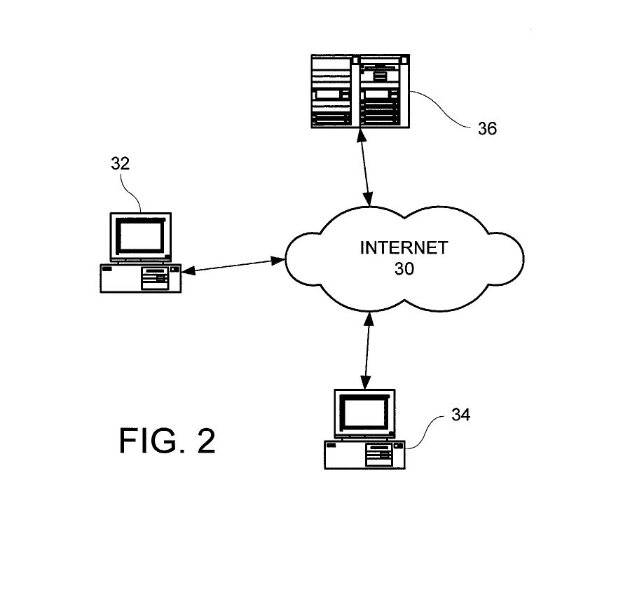

Referring to FIG. 2, the general network architecture of the present invention is illustrated. The user computer 32 is connected to a network 30 which is preferably, but without limitation, the Internet. When an application is launched, the application program launches the user's browser and directs the user to the URL of the server 36 that is hosting the chat room associated with the application that has been launched. The user can then conduct chat with other users of the application while at the same time using the application for its intended purpose.

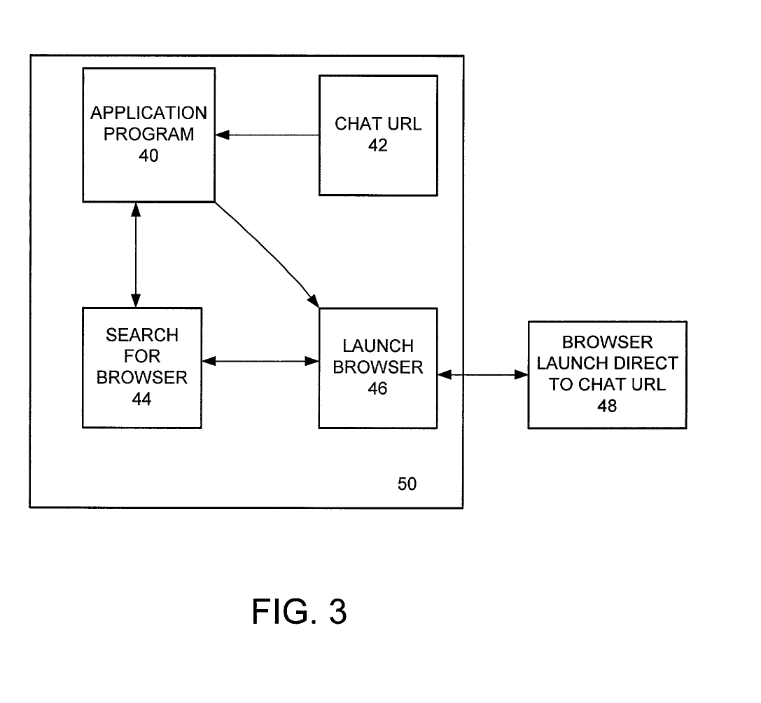

Referring to FIG. 3, an embodiment of an application having the function of the present invention is illustrated. In this illustration the application 50 comprises the application program 40, an already-identified chat URL 42, a browser searcher 44, and a browser launcher 46. When the application 50 is launched, the application program 40 causes a search for the user's browser to be conducted 44. If a browser is detected, the application program retrieves the associated chat URL 42 and provides it to the browser launcher 46, which launches the browser to the chat URL 48.

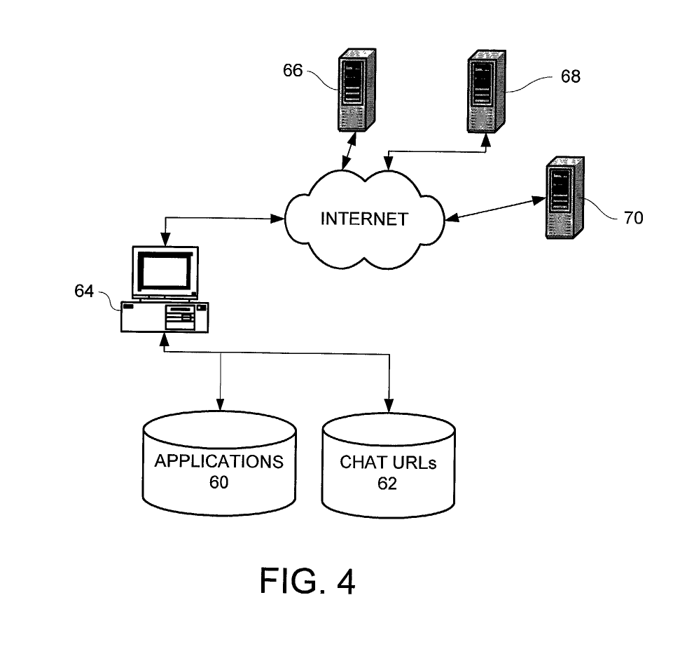

Referring to FIG. 4, yet another alternate embodiment of the present invention is illustrated. In this illustration, user computer 64 has a database of application programs 60. However, some of these programs may not have an embedded chat room URL. In this case, the program of the present invention can assist the user in preliminarily seeking a chat URL for each application and storing those chat URLs in a separate database or data file 62 with pointers from the application program to the associated chat URL. When an application is launched, the chat URL is automatically retrieved and the user's browser is launched to take the user to any specific server 66, 68, 70 that is associated with the application that is being used. The chat session related to that application program is then implemented.

Thus, the present invention is meant to cover not only those applications having the automatic chat embedded in the application itself, but is also deemed to cover a separate set of instructions that facilitates the automatic launching of a chat functionality, even if the automatic chat establishment is not present in the application's program.

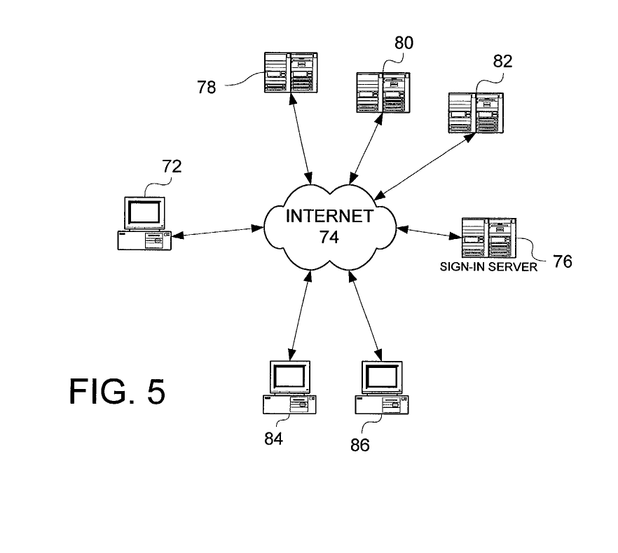

Referring to FIG. 5, operation according to a further alternate embodiment is illustrated. When a user launches a particular software application on the user computer 72, a chat room module is launched at the same time for the purpose of accessing a chat room via the Internet 74. As distinct from the embodiments described above, the chat room module implemented in this embodiment does not directly access a server running a chat room process. Rather, the user computer 72 is connected via the network 74 to a sign-in site on a designated sign-in server 76. In order to access the chat room that pertains to the particular software that the user has just launched, the chat room module at the user computer 72 requests access permission from the sign-in site. The sign-in server 76 accesses a cookie on the user computer 72 to verify whether the user is registered for access to the particular chat room the chat room module has requested. Once registration has been verified, the sign-in site then provides a network connection for the user computer 72 to the requested chat room that is hosted at one of several chat servers 78, 80, 82 for which the sign-in site acts as a gatekeeper. Preferably, the machines conduct all of these verification and connection activities in a manner that is transparent to the user.

A sign-in server 76 according to the embodiment of FIG. 5 is also useful for implementing the present invention using Instant Messaging (IM) rather that the chat room format. According to this alternate implementation, the sign-in server 76 provides (once registration is verified) the user with IM correspondence partners in the form of “buddy list” additions for customer service representatives 84, 86 of the software application provider. The user may then use the IM protocol to have near real time electronic conversations with those representatives.

According to yet another alternate embodiment, the chat functionality is provided independent of a browser. The network access and communication protocols to enable the chat functionality are programmed into a module included as an integral part of the application program itself. When the application is operating, it has a chat window that is embedded in the application, not conducted via a separate browser or chat module. No browser need be used or operating to effect this embodiment. Preferably an embedded chat window according to this embodiment is implemented as a 3 to 4 line window up in the upper right hand area of the application window, where the chat session would be going on automatically, every time the application is launched.

This chat room facility can run on any computer. Any typical workstations such as an IBM PC with Pentium processor having disk storage and random access memory will be satisfactory to run the chat room module along with the application.

An automatic chat room facility has now been illustrated. It would be apparent to those skilled in the art that other embodiments of this concept are possible without departing from the scope of the invention as disclosed.

What is claimed is:

1. A method for implementing a software application via a user computer so as to provide for help communications, the method comprising:
beginning execution of the software application on the user computer;
initiating, at the user computer, communication via a chat room process through a communication network.

2. The method for implementing a software application of claim 1, wherein the communication network is an open network.

3. The method for implementing a software application of claim 1, wherein the communication network is a global interconnected network of networks.

4. The method for implementing a software application of claim 1, wherein the chat room process is essentially dedicated to discussion concerning the software application.

5. The method for implementing a software application of claim 1, wherein the communication via a chat room process permits a user at the user computer to pose questions about the software application and to obtain answers to those questions in real time.

6. The method for implementing a software application of claim 1, wherein the communication via a chat room process permits a user at the user computer to pose questions about the software application and to obtain answers to those questions substantially contemporaneously.

7. The method for implementing a software application of claim 1, wherein the initiating is performed automatically and contemporaneously with the beginning execution.

8. A system for operating a software application while accessing a chat room over a network in an automatic fashion upon the launch of the software application, the system comprising:
a host computer operating a chat room; and
a user computer on which the software application is launched, the user computer being electronically connected to the host computer via the network, wherein the software application launched on the user computer includes a chat room module which automatically initiates a connection to the chat room operated by the host computer when the software application is launched.

9. The system for operating a software application of claim 8, wherein connection to the chat room is initiated by passing a network address of the host computer's chat room to a web browser on the user computer.

10. The system for operating a software application of claim 8, wherein the chat room operated by the host computer is essentially dedicated to discussion specific to the software application.
